(19) United States
(12) Patent Application Publication
(10) Pub. No.: US 2009/0157503 A1
(43) Pub. Date: Jun. 18, 2009

(54) PYRAMIDAL VOLUMES OF ADVERTISING SPACE

(75) Inventors: Karim Farouki, Seattle, WA (US); Blaise Aguera y Arcas, Seattle, WA (US); Brett Brewer, Sammamish, WA (US); Steven Drucker, Bellevue, WA (US); Gary W. Flake, Bellevue, WA (US); Stephen L. Lawler, Redmond, WA (US); Richard Szeliski, Bellevue, WA (US); Michael Fredrick Cohen, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/958,677

(22) Filed: Dec. 18, 2007

(51) Int. Cl. G06Q 30/00

(52) U.S. Cl. 705/14

(57) ABSTRACT

The claimed subject matter relates to an architecture that can facilitate advertising models in connection with pyramidal volumes of advertising space. In particular, a pixel at one plane of view of an image can be associated with four pixels at a lower plane of view and so on. Advertising rights with respect to the pixel can be offered for sale, which can include all, a subset, or a different set of advertising rights with respect to other pixels in the pyramidal volume. The architecture can construct the data for the image dynamically based upon contextual input and the advertising rights as well as image format can be constructed based upon notions of zoning.

### CROSS-REFERENCE TO RELATED APPLICATIONS

This application is related to U.S. Pat. No. 7,075,535, filed on Mar. 1, 2004, entitled “ZOOMING USER INTERFACE.” This application is related to U.S. Pat. No. 7,133,054, filed on Mar. 17, 2004, entitled “METHOD AND APPARATUS FOR NAVIGATING AN IMAGE.” The entireties of these applications are incorporated herein by reference.

### BACKGROUND

Conventionally, web-based ad space, such as webpages or advertisement content included in a webpage, is comprised of images or other visual components of a fixed spatial scale. Generally the fixed spatial scale is based upon settings associated with an output display screen resolution and/or the amount of screen real estate allocated to a viewing application, e.g. the size of a browser that is displayed on the screen to the user.

In addition to finite screen real estate associated with hardware displays, advertisers are further limited by the circumstance that ads are often only secondary content for most any website or page. Accordingly, ad space is generally relegated to small blocks of screen real estate, typically located at the top or along side panels of a web page. While many advertisers have created clever ways to attract a user's attention even with limited amounts of screen real estate, there exists a rational limit to how much information can be supplied by a finite display space under conventional advertising means, whereas actual transactions—the primary goal of the advertiser-usually necessitate a much greater amount of information be provided to the user.

Accordingly, most forms of web-based advertising rely almost exclusively on a click-through advertising model or mechanism in which a fixed spatial scale image is employed to encourage a potential customer to click the ad, whereby the potential customer can then be routed via hyperlink to more extensive amounts of information pertaining to the ad.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can augment or facilitate advertising models in connection with pyramidal volumes of advertising space. In accordance therewith and other related ends, the architecture can include a data structure with image data for a multiscale image that includes pyramidal volumes of advertising space. Thus, the image displayed can include multiple display layers or planes of view that are substantially parallel and that are alternatively displayable based upon a level of zoom. For example, zooming into a particular pixel at one plane of view can provide a seamless and realistic transition to lower planes of view, wherein each pixel can project a pyramidal volume to create an association with four pixels in the subsequent lower plane of view.

The architecture can further offer for sale advertising rights associated with a given pixel. The advertising rights can include rights to purchase or lease the pixel; or a right to sell or lease the pixel to a third party. In addition, the advertising rights can include rights relating to RGB features, hyperlinks, annotations, metadata, etc. for the pixel. In an aspect, the advertising rights associated with a first pixel can be extended to other pixels in the pyramidal volume created by projecting from the first pixel down to ever subsequent levels of zoom. The rights associated with pixels in the pyramidal volume can be the same as those for the first pixel, a subset, or include additional rights altogether.

In another aspect, the architecture can offer for sale the advertising rights based upon notions of zoning. For example, pixels can be ordered based upon the type or quality of the content or a pricing rate can be determined based upon an inferred value of the local “real estate.” For example, a pixel that appears near to very popular content can be priced higher than pixels that do not. In another aspect, the image data included in the data structure can be dynamically created in a manner that is not altogether different from mechanisms that dynamically select and populate advertising content in today's web pages. For example, the image data can be dynamically created based upon contextual input such as a search string, search results, user profiles, advertiser profiles, and so on.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a system that can facilitate advertising models in connection with pyramidal volumes of advertising space.

FIG. 2 depicts a block diagram of an example image 106 provided to facilitate a conceptual understanding of image data 104 and/or data structure 102.

FIG. 3 is a block diagram of a system that can facilitate multiple advertising models in connection with advertising rights for a pixel and associated volumes of space.

FIG. 4 depicts a block diagram of an example content display illustrating the case in which image 106 encompasses substantially all viewable content on a webpage.

FIG. 5 is a block diagram of an example content display that illustrates image 106 as a portion of a webpage.

FIG. 6 illustrates a block diagram of a computer implemented system that can aid with various inferences.

FIG. 7 depicts a block diagram of a computer implemented system that can enhance or facilitate display of image 106 based upon image data 104.

FIG. 8 is an exemplary flow chart of procedures that define a computer implemented method for employing pyramidal volumes of advertising space in connection with advertising models.

FIG. 9 illustrates an exemplary flow chart of procedures that define a computer implemented method for providing advertising rights in connection with the pixel.

FIG. 10 depicts an exemplary flow chart of procedures defining a computer implemented method for including notions of zoning and dynamic construction in connection with pyramidal volumes.

FIG. 11 illustrates a block diagram of a computer operable to execute the disclosed architecture.

FIG. 12 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

It is to be appreciated that the claimed subject matter can be utilized with at least one of a display engine, a browsing engine, a content aggregator, and/or any suitable combination thereof. A “display engine” can refer to a resource or component (e.g., hardware, software, and/or any combination thereof) that enables seamless panning and/or zooming of content within an environment in multiple scales, resolutions, and/or levels of detail, wherein detail can be related to a number of pixels dedicated to a particular object or feature that carry unique information. In accordance therewith, the term “resolution” is generally intended to be substantially similar to level of detail and to mean a number of pixels assigned to an object, detail, or feature of a displayed image and/or a number of pixels displayed using unique logical image data. Thus, conventional forms of changing resolution that merely assign more or fewer pixels to the same amount of image data can be readily distinguished. Moreover, the display engine can create space volume within the environment based on zooming out from a perspective view or reduce space volume within the environment based on zooming in from a perspective view. Furthermore, a “browsing engine” can refer to a resource or component (e.g., hardware, software, and/or any suitable combination thereof) that employs seamless panning and/or zooming at multiple scales with various resolutions for data associated with an environment, wherein the environment is at least one of the Internet, a network, a server, a website, a web page, and/or a portion of the Internet (e.g., data, audio, video, text, image, etc.). Additionally, a “content aggregator” can collect two-dimensional data (e.g., media data, images, video, photographs, metadata, etc.) to create a three dimensional (3D) virtual environment that can be explored (e.g., browsing, viewing, and/or roaming such content and each perspective of the collected content).

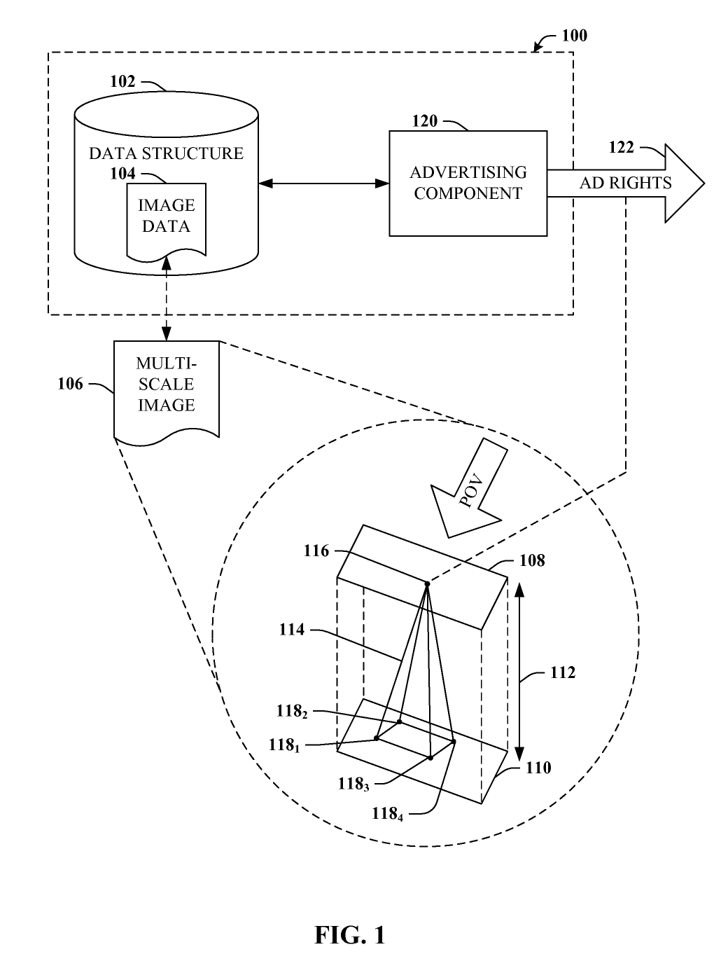

Referring now to the drawing, with reference initially to FIG. 1, computer implemented system 100 that can facilitate advertising models in connection with pyramidal volumes of advertising space is depicted. Generally, system 100 can include data structure 102 with image data 104 that can represent, define, and/or characterize computer displayable multiscale image 106. In particular, image 104 can include two or more substantially parallel planes of view (e.g., layers) that can be alternatively displayable, as encoded in image data 104 of data structure 102. For example, image 106 can include first plane 108 and second plane 110, as well as virtually any number of additional planes of view, any of which can be displayable and/or viewed based upon a level of zoom 112. For instance, planes 108, 110 can each include advertising content, such as on the upper surfaces that can be viewable in an orthographic fashion. At a higher level of zoom 112, first plane 108 can be viewable, while at a lower level zoom 112 at least a portion of second plane 110 can replace on an output device what was previously viewable.

Moreover, planes 108, 110, et al., can be related by pyramidal volume 114 such that, e.g., any given pixel in first plane 108 can be related to four particular pixels in second plane 110. It should be appreciated that the indicated drawing is merely exemplary, as first plane 108 need not necessarily be the top-most plane (e.g., that which is viewable at the highest level of zoom 112), and, likewise, second plane 110 need not necessarily be the bottom-most plane (e.g., that which is viewable at the lowest level of zoom 112). Moreover, it is further not strictly necessary that first plane 108 and second plane 110 be direct neighbors, as other planes of view (e.g., at interim levels of zoom 112) can exist in between, yet even in such cases the relationship defined by pyramidal volume 114 can still exist. For example, each pixel in one plane of view can be related to four pixels in the subsequent next lower plane of view, and to 16 pixels in the next subsequent plane of view, and so on. Accordingly, the number of pixels included in pyramidal volume at a given level of zoom, l, can be described as p=4^{l}, where l is an integer index of the planes of view and where l is greater than or equal to zero. It should be appreciated that p can be, in some cases, greater than a number of pixels allocated to image 106 (or a layer thereof) by a display device (or content schema component) such as when the display device allocates a relatively small number of pixels to image 106 with other content subsuming the remainder or when the limits of physical pixels available for the display device or a viewable area is reached. In these or other cases, p can be truncated or pixels described by p can become viewable by way of panning image 106 at a current level of zoom 112.

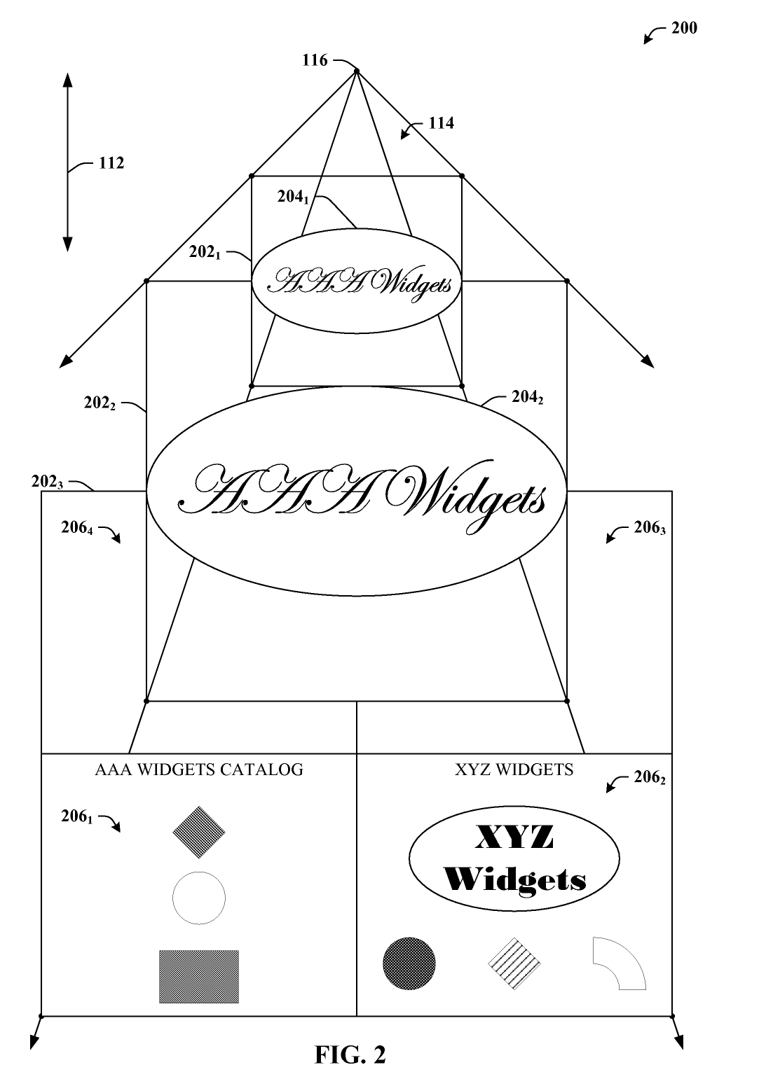

However, in order to provide a concrete illustration, first plane 108 can be thought of as a top-most plane of view (e.g., l=0) and second plane 110 can be thought of as the next sequential level of zoom 112 (e.g., l=1), while appreciating that other planes of view can exist below second plane 110, all of which can be related by pyramidal volume 114. Thus, a given pixel in first plane 108, say, pixel 116, can by way of a pyramidal projection be related to pixels 118₁-118₄ in second plane 110. The relationship between pixels included in pyramidal volume 114 can be such that content associated with pixels 118₁-118₄ can be dependent upon content associated with pixel 116 and/or vice versa. It should be appreciated that each pixel in first plane 108 can be associated with four unique pixels in second plane 110 such that an independent and unique pyramidal volume can exist for each pixel in first plane 108. All or portions of planes 108, 110 can be displayed by, e.g. a physical display device with a static number of physical pixels, e.g., the number of pixels a physical display device provides for the region of the display that displays image 106 and/or planes 108, 110. Thus, physical pixels allocated to one or more planes of view may not change with changing levels of zoom 112, however, in a logical or structural sense (e.g., data included in data structure 102 or image data 104) each successive lower level of zoom 112 can include a plane of view with four times as many pixels as the previous plane of view, which is further detailed in connection with FIG. 2, infra.

System 100 can also include advertising component 120 that can offer for sale advertising rights 122 in connection with pixel 116. Advertising rights 122 can be provided to advertisers such as, e.g. those who conventionally employ web-based advertising as a means for reaching potential customers. Advertising rights 122 can relate to or include a purchase of pixel 116, or a lease (e.g., time based ownership or rights) of pixel 116, either of which can include a right to sell or lease the pixel to a third party such as another suitable advertiser. More particularly, advertising rights 122 can include rights to a color displayed by pixel 116 or another RGB feature of pixel 116; a hyperlink associated with pixel 116; an annotation associated with pixel 116; metadata associated with pixel 116 and so forth.

According to an aspect, advertising rights 122 associated with pixel 116 can include substantially similar rights with respect to pixels 118₁-118₄ as well as to other pixels included in pyramidal volume 114 such as pixels at lower levels of zoom 112. For example, an advertiser who purchases advertising rights 122 for pixel 116 can also attain all, a subset, or a different set of rights with respect to other pixels included in pyramidal volume 114.

In other aspects of the claimed subject matter, an advertiser, for example, can purchase advertising rights 122 to ad space comprising multiple pixels in one or planes of view. While not strictly necessary the multiple pixels and/or ad space can be a contiguous block in one or several planes of view, generally within pyramidal volume 114. Appreciably, the contiguous block of pixels at one level of zoom 112 can include a large amount of information viewable in resolute detail relative to conventional ad space usage; yet, can also be viewable as a single pixel at a higher level of zoom 112. It should also be understood that advertising component 120 can facilitate sale of ad space comprising a contiguous block of pixels in which at least an RGB feature of one or more of the pixels included in the block of pixels changes over time. Accordingly, the ad space can include video content. These and other features can be further explained with reference to FIG. 2.

Turning now to FIG. 2, example image 106 is illustrated to facilitate a conceptual understanding of image data 104 and/or data structure 102. In this example, image 106 includes four planes of view, with each plane being represented by pixels that exist in pyramidal volume 114. For the sake of simplicity, each plane of view includes only pixels included in pyramidal volume 114; however, it should be appreciated that other pixels can also exist in any or all of the planes of view although such is not expressly depicted. For example, the top-most plane of view includes pixel 116, but it is readily apparent that other pixels can also exist as well. Likewise, although not expressly depicted, planes 202₁-202₃, which are intended to be sequential layers and to potentially exist at much lower levels of zoom 112 than pixel 116, can also include other pixels.

In general, planes 202₁-202₃ can represent ad space for an advertiser who purchases suitable advertising rights 122. In this case, the advertiser is “AAA widgets” who fills add space with the company's familiar trademark, logo 204₁. As the level of zoom 112 is lowered to plane 202₂, what is displayed in the ad space can be replaced by other data in accordance with advertising rights 122 so that a different layer of image 106 can be displayed, in this case logo 204₂. In an aspect of the claimed subject matter, one plane can display all or a portion of another plane at a different scale, which is illustrated by planes 202₂, 202₁, respectively. In particular, plane 202₂ includes about four times the number of pixels as plane 202₁, yet associated logo 204₂ need not be merely a magnified version of logo 204₁ that provides no additional detail and can lead to “chucky” rendering, but rather can be displayed at a different scale with an attendant increase in the level of detail, and/or where more unique image data 104 is associated with additional pixels.

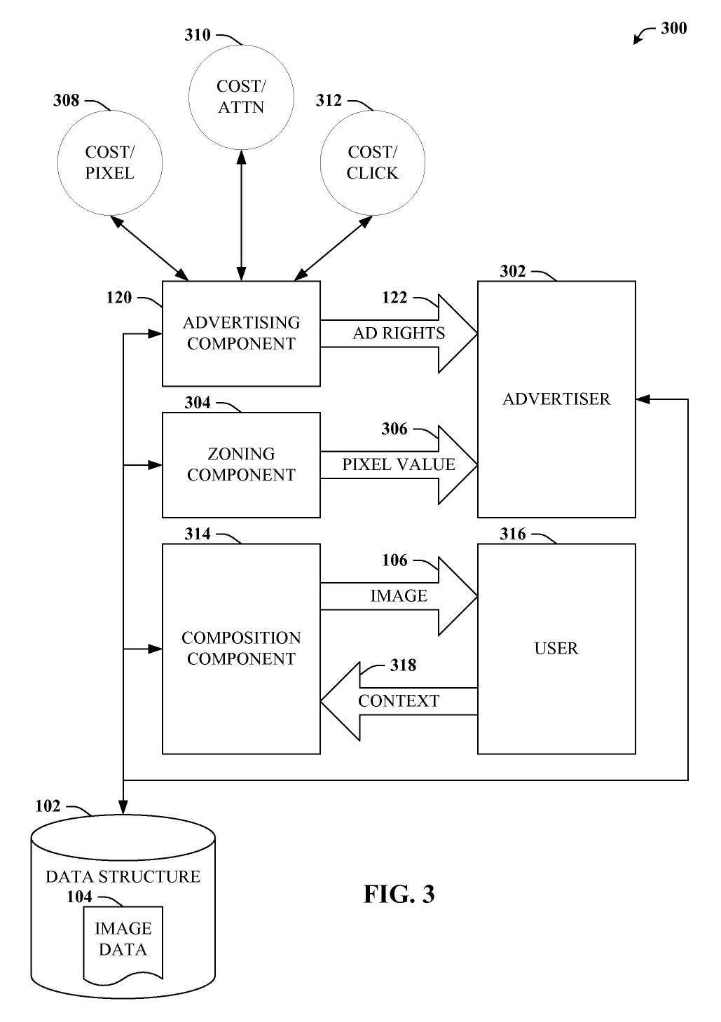

Additionally or alternatively, a lower plane of view can display advertising content that is graphically or visually unrelated to a higher plane of view (and vice versa). For instance, as depicted by planes 202₂ and 202₃ respectively, the content can change from logo 204₂ to, e.g. content described by reference numerals 206₁-206₄. Thus, in this case, the next level of zoom 112 provides a product catalog associated with the AAA Widgets company and also provides advertising content for a competitor, “XYZ Widgets” in the region denoted by reference numeral 206₂. Other content can be provided as well in the regions denoted by reference numerals 206₃-206₄. It should be underscored that, according to an aspect of the claimed subject matter, a plane of view can display advertising content from an advertiser who does not have advertising content included in a previous plane of view and/or who does not have advertising rights 122 associated with pixels in the previous plane of view. Such is illustrated by reference numeral 206₂, wherein XYZ Widgets has acquired advertising rights 122 even though the company has no similar rights at higher planes of view. Such rights can be acquired from advertising component 120 either directly from a host of the ad space, indirectly from an advertiser (e.g., AAA Widgets), or from another suitable means, further described with reference to FIG. 3.

By way of further explanation consider the following holistic example. Pixel 116 is output to a user interface device and is thus visible to a user, perhaps in a portion of viewable content allocated to advertising space. As the user zooms (e.g., changes the level of zoom 112) into pixel 116, additional planes of view can be successively interpolated and resolved and can display increasing levels of detail. Eventually, the user zooms to plane 202₁ and other planes that depict more detail at a different scale, such as plane 202₂. However, a successive plane need not be only a visual interpolation and can instead include content that is visually or graphically unrelated such as plane 202₃. Upon zooming to plane 202₃, the user can peruse the content displayed, possibly zooming into the product catalog to reach lower levels of zoom relating to individual products and so forth.

Additionally or alternatively, it should be appreciated that logos 204₁, 204₂ can be a composite of many objects, say, images of products included in one or more product catalogs that are not discernible at higher levels of zoom 112, but become so when navigating to lower levels of zoom 112, which can provide a realistic and natural segue into the product catalog featured at 206₁, as well as, potentially that for XYZ Widgets included at 206₂. In accordance therewith, a top-most plane of view, say, that which includes pixel 116 need not appear as advertising content, but rather can appear, e.g., as an aesthetically appealing work of art such as a landscape or portrait; or, less abstractly can relate to a particular domain such as a view of an industrial device related to widgets. Naturally countless other examples can exist, but it is readily apparent that pixel 116 can exist at, say, the stem of a flower in the landscape or at a widget depicted on the industrial device, and upon zooming into pixel 116 (or those pixels in relative proximity), logo 204₁ can become discernible.

With reference now to FIG. 3, system 300 that can facilitate multiple advertising models in connection with advertising rights for a pixel and associated volumes of space is provided. In general, system 300 is intended to illustrate addition features of system 100 depicted in FIG. 1, and can include advertising component 120 that can offer for sale, e.g., to advertiser 302, advertising rights 122 in connection with pixel 116, wherein pixel 116 can be described by image data 104 in a suitable data structure 102, as substantially describe supra. In addition, system 300 (as well as system 100) can further include zoning component 304 that can determine pixel value 306 of pixel 116 based upon values of nearby pixels at a common level of zoom and/or a common plane of view.

Pixel value 306 can relate to a category value as well as to a pricing value. For example, pixels comprising logo 204₁ (or plane 202₁) from FIG. 2 can be categorized based upon the content or based upon a business or advertising domain according to some schema or hierarchy such as, e.g. “manufacturers>industrial>parts>widgets.” Accordingly, zoning component 304 can classify pixels, ad space, ad content, and/or planes of view based upon such a schema, which can be recorded in pixel value 306. In another aspect, pixel value 306 can include a pricing value somewhat akin to conventional aspects of real estate or notions of ad space. For example, pixels in relative close proximity to other pixels that are well trafficked or have a high degree of visibility can be more highly valued than pixels without such proximity. Appreciably, zoning component 304 can employ steps or acts similar to conventional calculation of PageRank where, e.g. pixel proximity can be employed in lieu of hyperlinks from one page to another. In addition, zoning component 304 can weight pixel value 306 based upon the attendant plane of view or level of zoom 112 or based upon size of the display area allocated to image 106. Hence, pixels at lower levels of zoom 112 or at levels that are rarely visited can be priced accordingly as can pixels included in full-screed ads versus smaller ads.

For the sake of illustration, and referring briefly back to FIG. 2, consider an advertiser, “High-tech Widgets,” that desires ad exposure. While advertising rights 122 with respect to pixel 116 have already been acquired by AAA Widgets, High-tech can opt for pixels included in regions 206₃ or 206₄, as XYZ ostensibly did with region 206₂, potentially at more modest prices (e.g., pixel value 306) than would be available for pixels at higher planes of view. In addition, depending upon advertising rights 122, some pixels included in pyramidal volume 114 at higher levels can be available to High-tech. For instance, consider the blank portions of planes 202₁ and 202₂ not populated with logos 204₁ and 204₂, respectively. Pixels in these portions can be marked as “vacant” or “undeveloped,” for example by zoning component 304 and the vacancy flag can be included in pixel value 306 or in a determination thereof. While it is likely that advertising rights 122 for such pixels belong to AAA, there exists the possibility that AAA only attained rights to the pixels that comprise the respective logos 204₁, 204₂. However, in either case, such pixels might be extremely desirable to High-tech who can potentially negotiate or bid for those pixels, either directly with the host or with AAA depending on the situation. Thus, AAA can conceivably subsidize its own advertising budget by providing valuable ad space to High-tech. It should be further appreciated that High-tech can also seek advertising rights 122 to pixels that will exist between AAA and XYZ (e.g., regions 206₁, 206₂) at a lower level of zoom 112. In any case, zoning component 304 can determine or infer the values 306 of these pixels, which can be transmitted to other components, to the host, and/or to advertiser 302, and can be utilized in connection with various advertising models.

For example, advertising component 120 can employ pixel value 306 in connection with selling offers of advertising rights 122. Moreover, advertising component 120 can establish a price for advertising rights 122 based upon at least one of cost-per-pixel model 308, cost-per-attention model 310, cost-per-click model 312, or another suitable model. Cost-per-pixel model 308 can be based upon pricing values included in pixel value 306. Likewise, cost-per-click model 312 can be based upon well-known click-through mechanisms or schemes, while cost-per-attention model 310 can be based upon well-known metrics including but not limited to eye/iris tracking, an amount of time an ad or pixels is displayed, and so forth.

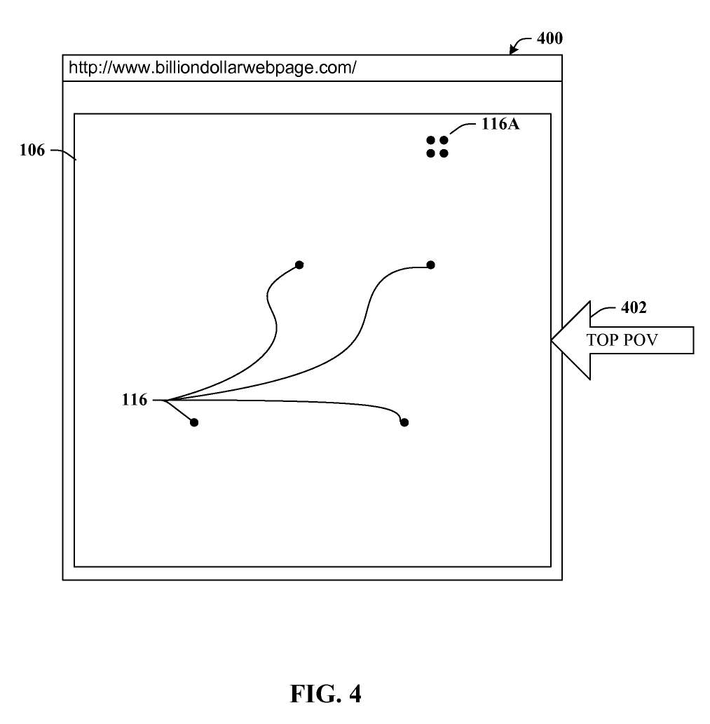

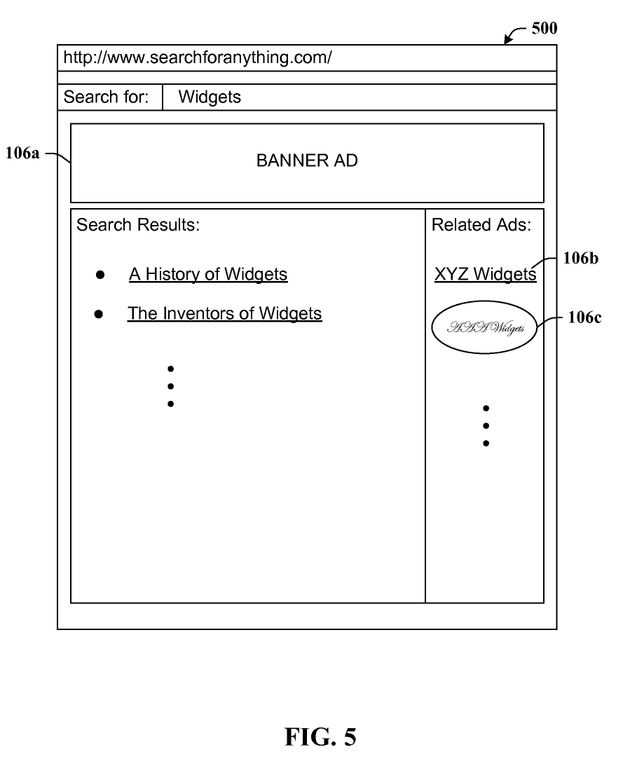

In addition, system 300 can include composition component 314 that can construct image data 104. For example, data structure 102 can be populated with image data 104 based upon advertising rights 122 assigned to various pixels included at each plane of view. Accordingly, image 106 can be viewable by user 316 by way of, e.g., a content or web browser. User 316 can be, e.g. a web user, a consumer advertising content, and/or an individual or entity visually exposed to image 106. Hence, in an aspect of the claimed subject matter, image 106 can encompass substantially all viewable content on a webpage and can be initialized at a top-most plane of view, as depicted in connection with FIG. 4. Additionally or alternatively, image 106 can be an advertisement extant on a webpage, an example of which can be found with reference to FIG. 5.

Furthermore, composition component 314 can dynamically construct image data 104 based upon contextual input 318. Contextual input 318 can be provided by user 316 and can be based upon, e.g., a search string or other contextual information such as keywords, metadata, a profile associated with user 316 (e.g. demographics, transaction history, preferences . . . ), and so on. Appreciably, composition component 314 can populate data structure 102 with quite dissimilar image data 104 when a search string (or other contextual information) is “cars” as opposed to “widgets.” Similarly, contextual input 318 can be based upon search results. Accordingly, given that composition component 314 can dynamically construct image 106 on the fly, conventional forms of advertisement-based images relating to contextual information can be augmented or replaced entirely by images 106, potentially without the need to dramatically change what contextual information is utilized or obtained or necessarily how content is selected.

In accordance with the foregoing, it should be readily apparent that the claimed subject matter leads away from current web- or computer-based advertising and/or market trends. For example, current trends are represented by the notion of redirecting a user away from a current website or a current set of displayed content, or directed to launching another application or browser instance in order to view additional data sets or details.

Referring to FIG. 4, example content display 400 illustrating the case in which image 106 encompasses substantially all viewable content on a webpage is provided. Content display 400 can be facilitated by way of, e.g. a web browser in which image 106 constitutes substantially all visible content in a viewable area. Hence, upon navigating to a particular web address (e.g., a uniform resource locator/identifier), say the “Billion Dollar Webpage” located at “http://www.billiondollarwebpage.com,” top-most plane of view 402 can be initially displayed. Included in plane of view 402 can be a matrix of pixels 116, some of which are arbitrarily labeled, including a block of pixels 116A. As detailed supra, advertising rights 122 can be offered for sale in connection with each pixel 116, and, moreover, each pixel 116 can be associated with a pyramidal volume projected upon lower levels of zoom 112. Accordingly, a user can employ realistic panning and zooming to navigate not only top-most plane of view 402, but also any related lower plane of view, all of which can be observed with a relatively large display surface.

Turning briefly to FIG. 5, example content display 500 that illustrates image 106 as a portion of a webpage is depicted. For example, image 106 can be included as, e.g. an advertisement extant on the webpage such as a banner ad or contextual ads relating to search results. As one example, user 316 can navigate a browser to a site or webpage that provides a search engine. Customarily user 316 can enter a search string such, in this case, the word “widgets,” and be subsequently presented with search results. In addition, it is common for the search results to include one or both of a banner ad or a side panel of contextual advertisements. Conventional images or text-based ads included in such ad space can be replaced by image 106, as detailed herein. In particular, example image 106a can replace a conventional banner ad, example images 106b and 106c can replace anchor text and/or text-based hyperlinks as well as graphics based ads. It should be appreciated that FIGS. 4 and 5 are intended to be merely exemplary but not necessarily to limit the scope of the appended claims to just that which is depicted and described, as it is readily understood that other aspects, embodiments and/or features can be provided.

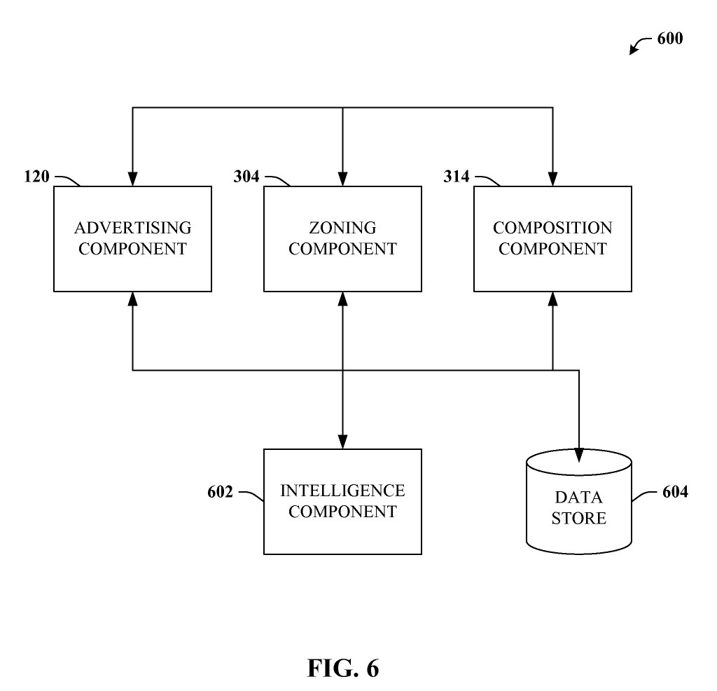

Turning now to FIG. 6, system 600 that can aid with various inferences is depicted. In general, system 600 can include advertising component 120 that can, e.g., intelligently determine advertising rights 122 that should be associated (and offered for sale in connection) with pixel 116 as well as pixels included in associated pyramidal volume 114. For example, while such can be decided based upon negotiations with, e.g., advertiser 302 or based upon default arrangements or policies, determinations or inferences relating to advertising rights 122 can also be dynamically set or adjusted based upon, e.g. previous transactions with a particular advertiser 302, current market conditions, consumer satisfaction, product or advertising domain and so forth.

System 600 can also include zoning component 304 that can intelligently determine or infer pixel value 306. For example, various machine learning techniques can be employed such that approaches to pixel value 306 can adapt or evolve over time based upon, e.g., comparisons between historical data sets, potentially differing across different product/advertisement domains. Likewise, system 600 can further include composition component 314 that can intelligently construct image data 104 in real time based upon contextual input 318 by, e.g. selecting suitable advertisement content and arranging the content within one or more planes of view.

In addition, system 600 can also include intelligence component 602 that can provide for or aid in various inferences or determinations. It is to be appreciated that intelligence component 602 can be operatively coupled to all or some of the aforementioned components. Additionally or alternatively, all or portions of intelligence component 602 can be included in one or more of the components 120, 304, 314. Moreover, intelligence component 602 will typically have access to all or portions of data sets described herein, such as data store 604, and can furthermore utilize previously determined or inferred data. Data store 604 can include one or more data structures 102 with associated image data 104 as well as numerous other data sets or information described herein or otherwise suitable and can be centralized or distributed, potentially across multiple devices and/or schemas.

In accordance therewith, in order to provide for or aid in the numerous inferences described herein, intelligence component 602 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

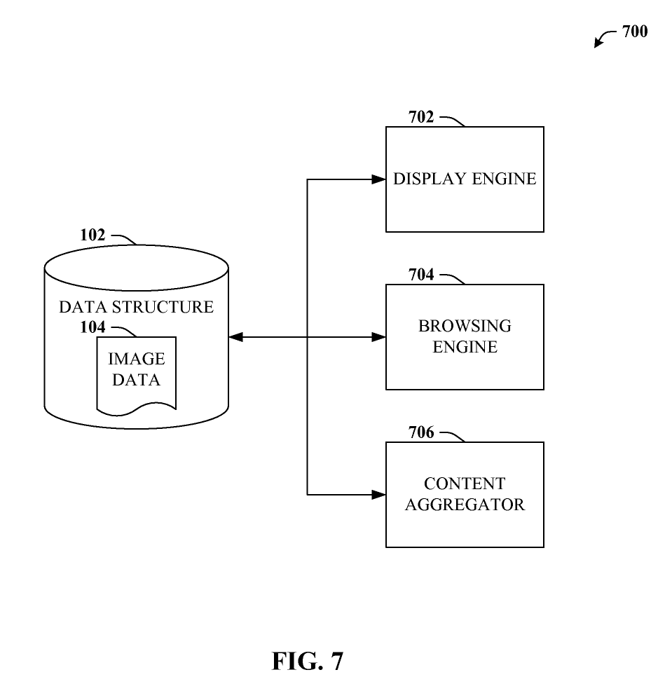

Turning now to FIG. 7, example system 700 that can enhance or facilitate display of image 106 based upon image data 104 is illustrated. Typically, system 700 can include display engine 702 that can enable seamless and/or realistic pan or zoom interaction with any suitable display of image data 104, wherein such data 104 can include multiple scales or planes of views and one or more resolutions or levels of detail associated therewith. In other words, display engine 702 can manipulate an initial default view for displayed data 104 by enabling zooming (e.g., zoom in, zoom out, etc.) and/or panning (e.g. pan up, pan down, pan right, pan left, etc.) in which such zoomed or panned content can include various detail or resolution qualities. Display engine 702 can enable visual information to be smoothly browsed regardless of the amount of data involved or bandwidth of a network. Moreover, display engine 702 can be employed with any suitable display or screen (e.g., portable device, cellular device, monitor, plasma television, etc.). Display engine 702 can further provide at least one of the following benefits or enhancements: 1) speed of navigation can be independent of size or number of objects included in data 104; 2) performance can depend on a ratio of bandwidth to pixels on a screen or display or an area allocated to image 106; 3) transitions between views can be smooth; or 4) scaling is near perfect and rapid for screens or images of any resolution.

For example, image 106 can be viewed at a default level with a specific resolution and level of detail. Yet, display engine 702 can allow image 106 to be zoomed and/or panned at multiple scales, planes of view, or levels of detail (in comparison to the default view) with various resolutions. Thus, user 316 can zoom in on a portion of image 106 such that a greater number of pixels can be devoted to a particular region of content, for example. By enabling the website to be zoomed and/or panned, image 106 can include virtually limitless space or volume that can be viewed or explored at various scales, planes of view, or levels of detail. In other words, image 106 can be viewed at a more granular level while maintaining resolution with smooth transitions independent of pan, zoom, etc. Moreover, a higher plane of view may not expose portions of information or data included in image 106, while modifying zoom or pan with display engine 702 can do so.

Browsing engine 704 can also be included with system 700. Browsing engine 704 can leverage display engine 702 to implement seamless and smooth panning and/or zooming for any suitable data browsed in connection with at least one of the Internet, a network, a server, a website, a web page, and the like. It is to be appreciated that browsing engine 704 can be a stand-alone component, incorporated into a browser, utilized in combination with a browser (e.g., legacy browser via patch or firmware update, software, hardware, etc.), and/or any suitable combination thereof. For example, browsing engine 704 can incorporate Internet browsing capabilities such as seamless panning and/or zooming into an existing browser. For example, browsing engine 704 can leverage display engine 702 in order to provide enhanced browsing with seamless zoom and/or pan on a website, wherein various scales or views can be exposed by smooth zooming and/or panning.

System 700 can further include content aggregator 706 that can collect a plurality of two dimensional (2D) content (e.g. media data, images, video, photographs, metadata, etc.) to create a three dimensional (3D) virtual environment that can be explored (e.g., displaying each image and perspective point). In order to provide a complete 3D environment to a user within the virtual environment, authentic views (e.g., pure views from images) can be combined with synthetic views (e.g. interpolations between content such as a blend projected onto the 3D model). For instance, content aggregator 706 can aggregate a large collection of photos of a place or an object, analyze such photos for similarities, and display such photos in a reconstructed 3D space, depicting how each photo relates to the next. It is to be appreciated that the collected content can be from various locations (e.g., the Internet, local data, remote data, server, network, wirelessly collected data, etc.). For instance, large collections of content (e.g., gigabytes, etc.) can be accessed quickly (e.g. seconds, etc.) in order to view a scene from virtually any angle or perspective. In another example, content aggregator 706 can identify substantially similar content and zoom in to enlarge and focus on a small feature or element. Content aggregator 706 can provide at least one of the following: 1) walk or fly through a scene to see content from various angles; 2) seamlessly zoom in or out of content independent of resolution (e.g., megapixels, gigapixels, etc.); 3) locate where content was captured in relation to other content; 4) locate similar content to currently viewed content; and 5) communicate a collection or a particular view of content to an entity (e.g., user, machine, device, component, etc.).

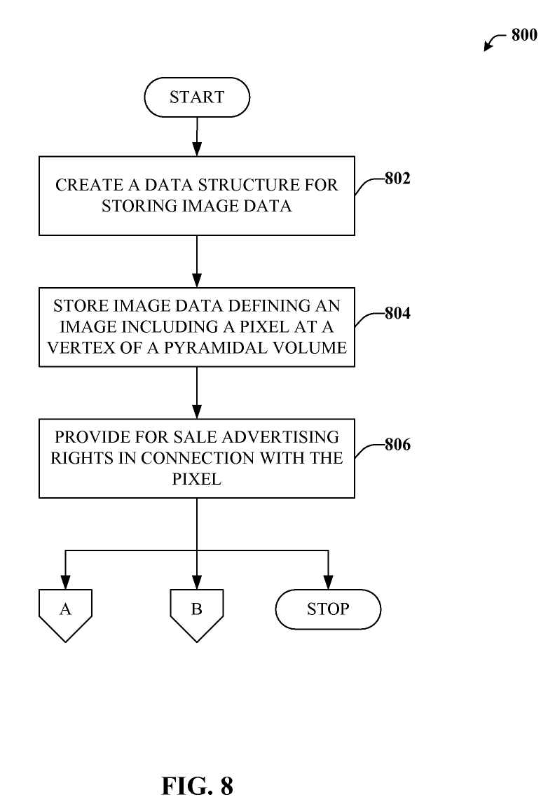

FIGS. 8, 9, and 10 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

With reference now to FIG. 8, exemplary computer implemented method 800 for employing pyramidal volumes of advertising space in connection with advertising models is illustrated. Generally, at reference numeral 802, a data structure for storing image data can be created. The image data (and data structure) can be materially distinct from conventional image data in that an associated image can be multi-scale and/or can depict views at various levels of detail.

At reference numeral 804, image data can be stored to the data structure. More specifically, the stored image data can define a computer displayable image with at least two substantially parallel planes of view, wherein a first plane and a second plane can be displayable in the alternative based upon a level of zoom. Moreover, the first and second planes of view can be associated by a pyramidal volume with the image including a pixel at a vertex of the pyramidal volume. At reference numeral 806, advertising rights in connection with the pixel can be provided for sale to, e.g. an advertiser or another party interested in ad space.

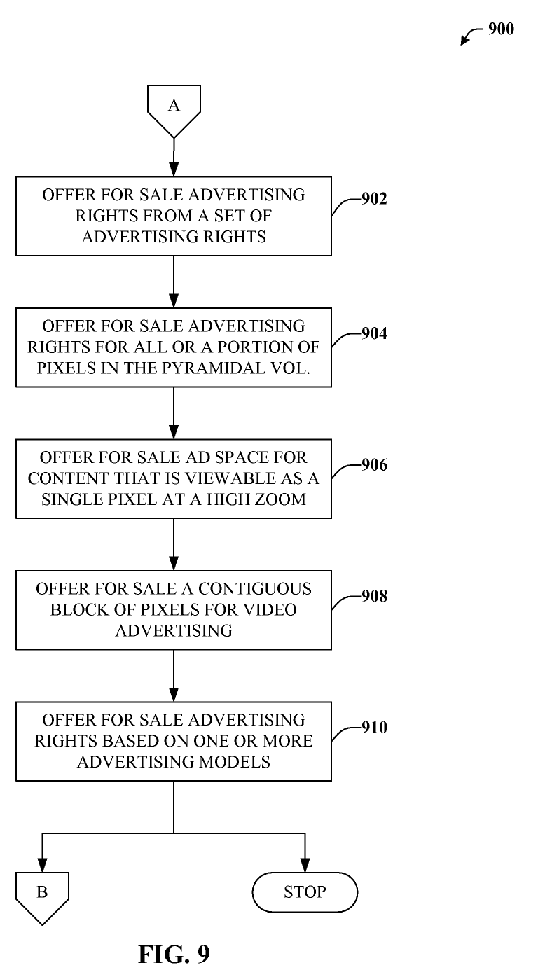

Referring to FIG. 9, exemplary method 900 for providing advertising rights in connection with the pixel is depicted. In general, method 900 is intended to provide additional feature with respect to the act of providing for sale advertising rights described at act 806, supra. At reference numeral 902, advertising rights including at least one of a purchase of the pixel, a lease of the pixel, a right to sell or lease the pixel to a third party, an RGB feature of the pixel, a hyperlink associated with the pixel, an annotation associated with the pixel, metadata associated with the pixel can be offered for sale.

At reference numeral 904, advertising rights for all or a portion of pixels included in the pyramidal volume can be offered for sale. For example, all or part or a different set of the advertising rights associated with the pixel can be extended to other pixels included in the pyramidal volume that can be constructed by a pyramidal projection from the pixel to pixels at lower levels of zoom. At reference numeral 906, ad space for advertising content viewable in detail at a lower level of zoom and viewable at a higher level of zoom as a single pixel can be offered for sale. Notably, content viewable in detail can imply that a relatively high number of pixels are devoted to the display of certain objects, features, or details.

At reference numeral 908, a contiguous block of pixels can be employed for video advertising content, rights to which can also be offered for sale. For example, pixels included in the block of pixels can dynamically change RGB features based upon particular timing. At reference numeral 910, advertising rights can be offered for sale based upon at least one of a cost-per-pixel ad model, a cost-per-attention ad model, or a click-through ad model. Appreciably, as with advertising rights, the various ad models can be extended to include not only the pixel, but other pixels within the pyramidal volume.

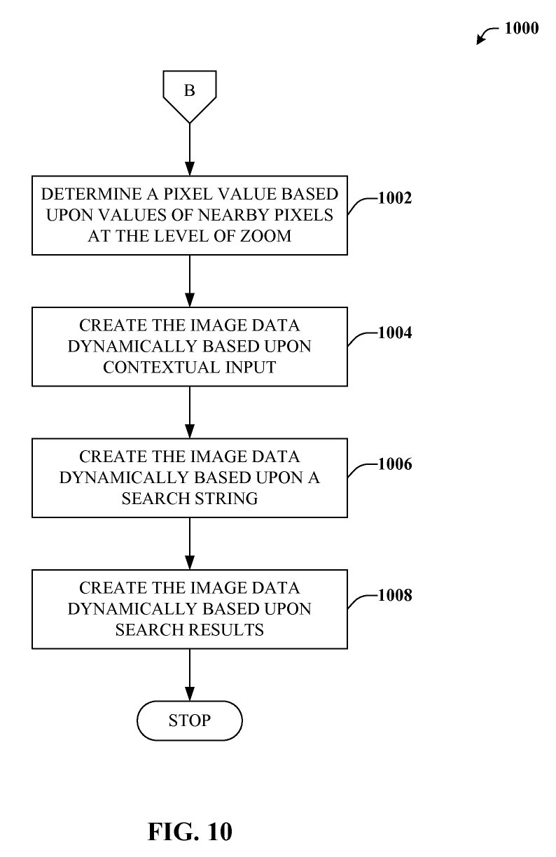

Turning briefly to FIG. 10, method 1000 for including notions of zoning and dynamic construction in connection with pyramidal volumes is illustrated. Generally, at reference numeral 1002, a pixel value can be determined based upon values of nearby pixels at the level of zoom. For example, the pixel value can relate to a classification value (e.g. market domain, advertising style, content type . . . ) as well as to a pricing value (e.g., a price at which advertising rights can be acquired). In accordance therewith, a notion of zoning can apply to advertising rights as well as to one or more associated advertising models.

At reference numeral 1004, the image data can be dynamically created based upon contextual input; at reference numeral 1006, the image data can be dynamically created based upon a search string; and at reference numeral 1008, the image data can be dynamically created based upon search results. In each of the above case, the image can be constructed on the fly and can be in whole or in part on a level-by-level basis. For example, only the top-most level or a relatively small number of upper levels need be initially constructed, and addition levels or layers can be similarly constructed dynamically based upon the level of zoom and the composition of pyramidal volumes.

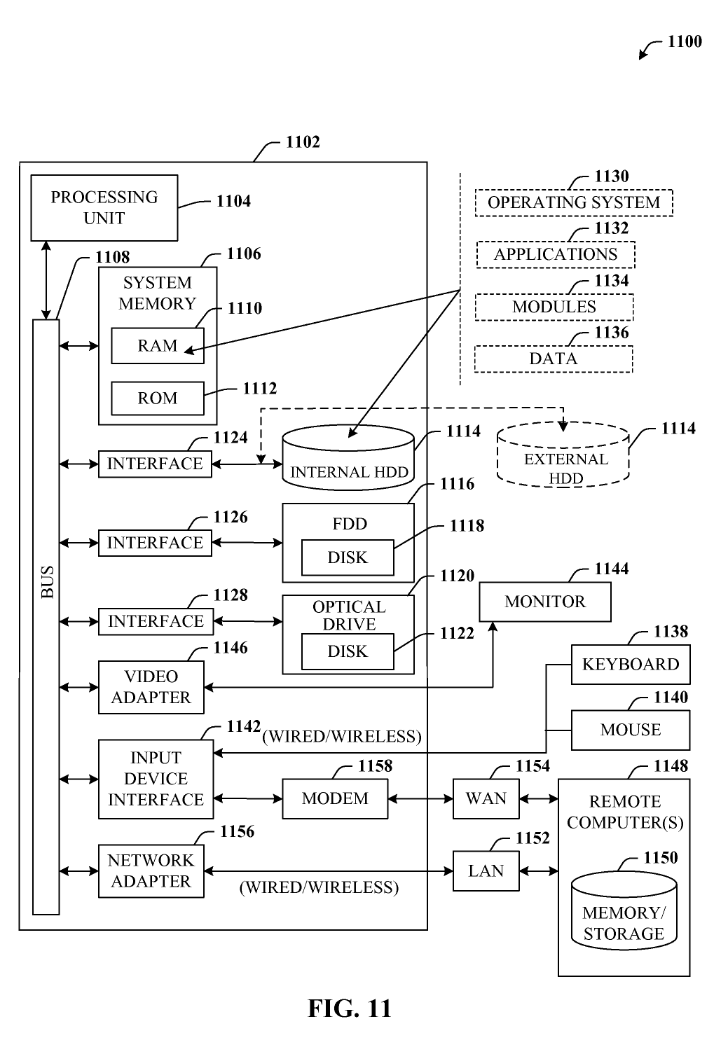

Referring now to FIG. 11, there is illustrated a block diagram of an exemplary computer system operable to execute the disclosed architecture. In order to provide additional context for various aspects of the claimed subject matter, FIG. 11 and the following discussion are intended to provide a brief, general description of a suitable computing environment 1100 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, the exemplary environment 1100 for implementing various aspects of the claimed subject matter includes a computer 1102, the computer 1102 including a processing unit 1104, a system memory 1106 and a system bus 1108. The system bus 1108 couples to system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the claimed subject matter can be implemented with various commercially available operating systems or combinations of operating systems.

A user can enter commands and information into the computer 1102 through one or more wired/wireless input devices, e.g. a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g. a wide area network (WAN) 1154. Such LAN and WAN networking environments are commonplace in offices and companies, and facilitate enterprise-wide computer networks, such as intranets, all of which may connect to a global communications network, e.g. the Internet.

When used in a LAN networking environment, the computer 1102 is connected to the local network 1152 through a wired and/or wireless communication network interface or adapter 1156. The adapter 1156 may facilitate wired or wireless communication to the LAN 1152, which may also include a wireless access point disposed thereon for communicating with the wireless adapter 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “10BaseT” wired Ethernet networks used in many offices.

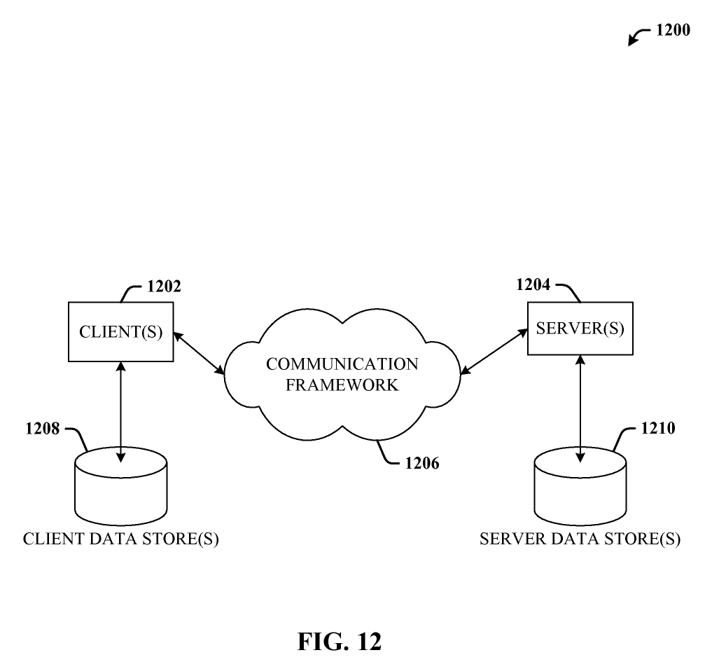

Referring now to FIG. 12, there is illustrated a schematic block diagram of an exemplary computer compilation system operable to execute the disclosed architecture. The system 1200 includes one or more client(s) 1202. The client(s) 1202 can be hardware and/or software (e.g., threads, processes, computing devices). The client(s) 1202 can house cookie(s) and/or associated contextual information by employing the claimed subject matter, for example.

The system 1200 also includes one or more server(s) 1204. The server(s) 1204 can also be hardware and/or software (e.g., threads, processes, computing devices). The servers 1204 can house threads to perform transformations by employing the claimed subject matter, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer implemented system that facilitates advertising models in connection with pyramidal volumes of advertising space, comprising:
a data structure with data that represents a computer displayable multiscale image with at least two substantially parallel planes of view in which a first plane and a second plane are alternatively displayable based upon a level of zoom and which are related by a pyramidal volume, the image includes a pixel at a vertex of the pyramidal volume; and
an advertising component that offers for sale advertising rights in connection with the pixel.

2. The system of claim 1, the advertising rights include at least one of a purchase of the pixel, a lease of the pixel, a right to sell or lease the pixel to a third party, an RGB feature of the pixel, a hyperlink associated with the pixel, an annotation associated with the pixel, metadata associated with the pixel.

3. The system of claim 1, the pixel is extant in the first plane of view and the advertising rights include substantially similar rights with respect to four pixels of the second plane that are included in the pyramidal volume projected from the pixel.

4. The system of claim 1, the advertising rights include substantially similar rights with respect to all or a portion of pixels at a lower level of zoom and that are included in the pyramidal volume.

5. The system of claim 1, the advertising component facilitates sale of ad space for advertising content viewable in detail at a lower level of zoom and viewable at a higher level of zoom as a single pixel.

6. The system of claim 1, the advertising component facilitates sale of ad space comprising a contiguous block of pixels in which at least an RGB feature of one or more of the block of pixels changes over time in order to facilitate video advertising content.

7. The system of claim 1, the second plane of view displays a portion of the first plane of view at a different scale.

8. The system of claim 1, the second plane of view displays advertising content that is graphically or visually unrelated to the first plane of view.

9. The system of claim 1, the second plane of view displays advertising content from an advertiser who does not have advertising content included in the first plane of view.

10. The system of claim 1, further comprising a zoning component that determines a value of the pixel based upon values of nearby pixels at the level of zoom.

11. The system of claim 1, the advertising component provides the advertising rights in accordance with at least one of a cost-per-pixel revenue model, a cost-per-attention revenue model, or a click-through revenue model.

12. The system of claim 1, the image encompasses substantially all viewable content on a webpage and initializes at a top-most plane of view.

13. The system of claim 1, the image is an advertisement extant on a webpage.

14. The system of claim 1, further comprising a composition component that dynamically constructs the data based upon contextual input.

15. The system of claim 14, the contextual input is based upon a search string.

16. The system of claim 14, the contextual input is based upon search results.

17. A computer implemented method for employing pyramidal volumes of advertising space in connection with advertising models, comprising:
creating a data structure for storing image data;
storing to the data structure image data defining a computer displayable image with at least two substantially parallel planes of view in which a first plane and a second plane are displayable in the alternative based upon a level of zoom and associated by a pyramidal volume, the image including a pixel at a vertex of the pyramidal volume; and
providing for sale advertising rights in connection with the pixel.

18. The method of claim 17, further comprising at least one of the following acts:
offering for sale advertising rights including at least one of a purchase of the pixel, a lease of the pixel, a right to sell or lease the pixel to a third party, an RGB feature of the pixel, a hyperlink associated with the pixel, an annotation associated with the pixel, metadata associated with the pixel;
offering for sale advertising rights for all or a portion of pixels included in the pyramidal volume at a lower level of zoom;
offering for sale ad space for advertising content viewable in detail at a lower level of zoom and viewable at a higher level of zoom as a single pixel;
offering for sale a contiguous block of pixels for video advertising content; or
offering for sale advertising rights based on at least one of a cost-per-pixel ad model, a cost-per-attention ad model, or a click-through ad model.

19. The method of claim 17, further comprising at least one of the following acts:
determining a pixel value based upon values of nearby pixels at the level of zoom;
creating the image data dynamically based upon contextual input;
creating the image data dynamically based upon a search string; or
creating the image data dynamically based upon a search results.

20. A computer implemented system for employing advertising models in connection with pyramidal volumes of advertising space, comprising:
computer implemented means for constructing a data structure for collecting image data;
computer implemented means for saving to the data structure image data defining a computer displayable image with at least two substantially parallel planes of view in which a first plane and a second plane are displayable in the alternative based upon a level of zoom and associated by a pyramidal volume, the image including a pixel at a vertex of the pyramidal volume; and
computer implemented means for offering for sale advertising rights in connection with the pixel.
